(19) United States
(12) Patent Application Publication
(10) Pub. No.: US 2022/0009091 A1
(43) Pub. Date: Jan. 13, 2022

(54) METHOD FOR DETERMINING A GRASPING HAND MODEL

(71) Applicants: Naver France, Meylan (FR); Consejo Superior de Investigaciones Cientificas (CSIC), Madrid (ES); Universitatpolitècnica De Catalunya Plaça d'Eusebi Güell 6 Edifici Vertex, Planta 1, Barcelona (ES)

(72) Inventors: Francesc Moreno Noguer, Barcelona (ES); Guillem Alenyà Ribas, Barcelona (ES); Enric Corona Puyane, Barcelona (ES); Albert Pumarola Peris, Barcelona (ES); Grégory Rogez, Meylan (FR)

(73) Assignees: Naver France, Meylan (FR); Consejo Superior de Investigaciones Cientificas (CSIC), Madrid (ES); Universitatpolitècnica De Catalunya Plaça d'Eusebi Güell 6 Edifici Vertex, Planta 1, Barcelona (ES)

(21) Appl. No.: 17/341,970

(22) Filed: Jun. 8, 2021

Related U.S. Application Data
(60) Provisional application No. 63/208,231, filed on Jun. 8, 2021.

(30) Foreign Application Priority Data
Jun. 9, 2020 (ES) 202030553

(51) Int. Cl. B25J 9/16

(52) U.S. Cl. CPC B25J 9/163; B25J 9/1697; B25J 9/1666; B25J 9/161; B25J 9/1653; B25J 9/1612

(57) ABSTRACT

Method for determining a grasping hand model suitable for grasping an object by obtaining a first RGB image including at least one object; obtaining an object model estimating a pose and shape of said object from the first image of the object; selecting a grasp taxonomy from a set of grasp taxonomies by means of a Convolutional Neural Network, with a cross entropy loss, thus, obtaining a set of parameters defining a coarse grasping hand model; refining the coarse grasping hand model, by minimizing loss functions referring to the parameters of the hand model for obtaining an operable grasping hand model while minimizing the distance between the finger of the hand model and the surface of the object and preventing interpenetration; and obtaining a mesh of the hand represented by the enhanced set of parameters.

### PRIORITY INFORMATION

The present application claims priority, under 35 USC § 119(e), from U.S. Provisional Patent Application Ser. No. 63/208,231, filed on Jun. 8, 2021. The entire content of U.S. Provisional Patent Application Ser. No. 63/208,231, filed on Jun. 8, 2021, is hereby incorporated by reference.

Pursuant to 35 U.S.C.§ 119 (a), this application claims the benefit of earlier filing date and right of priority to Spanish Patent Application Number ES 202030553, filed on Jun. 9, 2020. The entire content of Spanish Patent Application Number ES 202030553, filed on Jun. 9, 2020 is hereby incorporated by reference.

### BACKGROUND

In the state of the art, learning from human demonstrations (LfD) is a popular approach for teaching robots new skills without explicitly programming them. In LfD, a robot follows the example of a person whose body or hand pose is extracted and imitated by the robot's own kinematic configuration.

This learning paradigm, however, requires the human to perform the same task, or a very similar one, to the task to be learned by the robot.

Robotic grasping is a widely investigated topic, wherein most of the previous approaches have considered simple grippers with a reduced number of contact points, which would be equivalent to a human hand grasping an object using only two fingers.

Some recent approaches have studied human centered tasks based on deep learning algorithms, such as pose estimation, reconstruction, and motion prediction.

Hand pose estimation has been largely studied in recent years, partially spurred by the availability of numerous annotated datasets and the emergence of low-cost commodity depth sensors.

Nevertheless, most of these studies tackle hand pose estimation from RGB-D images, leveraging the 2.5D information contained in depth images to directly predict 3D hand joint locations.

Even more recently, some effort has been made to tackle the more challenging task of 3D hand shape prediction, instead of 3D joint location, from RGB images. These methods are based on the parametric model MANO (see Javier Romero, Dimitrios Tzionas, and Michael J. Black, “Embodied hands: Modeling and capturing hands and bodies together” SIGGRAPH, 36(6), November 2017, which is incorporated herein by reference), which provides a 51 degrees of freedom (DoF) low-dimensional representation of the space of all possible human hands. A differentiable layer that deterministically maps from pose and shape parameters to hand joints and vertices allows deep models to be trained using performance metrics on the 3D mesh.

In this field, although earlier work was based on iterative optimization or comparisons to a reference database, recent methods make use of deep learning.

Some works have tackled also hand pose estimation in the more complex scenario of a hand, or two hands, grasping or manipulating an object. The significant occlusions resulting from the manipulated object make the problem much more difficult compared to observing an isolated hand.

Most of these works consider solid objects, who deal with deformable objects. For example, some approaches solve the problem as a classification task over a taxonomy of 71 grasps, wherein each grasp corresponds to a particular hand pose and certain contact points and forces. Other approaches recently proposed datasets to predict possible grasping contact points directly on the objects.

Other recent works jointly predict object and hand pose, or object and hand 3D meshes. Also, synthetic datasets of hands grasping objects have been built using a simulator, called GraspIt Simulator.

Also, several grasp taxonomies have been proposed in the past, representing grasps in manufacturing tasks, also including a variety of unusual grasps and features such as grasp force, motion and stiffness and, more recently, including also manipulation primitives for cloth handling based on hand object contacts characterized as point, line and plane.

Other works have suggested to automatically define a taxonomy by clustering joint positions in a data-oriented approach to better understand activities or grasping poses.

Past works have mainly tried to predict saliency points in objects for grasping, applying deep learning to detect graspable regions of an object. Mostly, these grasps are predicted from the 3D structure of the object, first sampling thousands of grasp candidates and, then, pushing an open robot gripper until making contact with a mesh of the object. Then, the grasp candidates not containing parts of the point-cloud between fingers are discarded, and a grasp quality is classified using convolutional neural networks. This approach is similar to the one used in GraspIt simulator, which allows the simulation of grasps for given hand and object 3D models.

Thus, it is desirable to provide a method for determining a grasping hand model which emulates how a human would naturally grasp one or several objects, given at least one image of these objects.

It is further desirable to provide a method intended for outputting an operable hand model showing several contact points with the target object but no intersection with other elements of the scene for predicting human grasp, i.e., the most probable hand shape and pose that would allow to grasp an observed object, wherein a hand model is defined by a hand pose and shape, and grasp type.

### BRIEF DESCRIPTION OF THE DRAWINGS

To complement the description and to aid towards a better understanding of the characteristics of the invention, in accordance with an example of a practical embodiment thereof, a set of drawings is attached as an integral part of said description wherein, with illustrative and non-limiting character, the following has been represented:

FIG. 1 illustrates grasping hand models obtained for the objects in the images;

FIG. 2 sets forth steps of a training method for annotating images so as to train the neural networks for obtaining grasping hand models;

FIG. 3 illustrates a comparison between the method and a GraspIt simulator;

FIG. 4 illustrates a representation of the method;

FIG. 5 illustrates an input image (left), predicted grasp when estimating the object 3D shape (middle) and when using the ground-truth object shape (right);

FIG. 6 illustrates impact of the optimization layer, both in the hand-object reconstruction pipeline (left) and in the grasp prediction pipeline (right);

FIG. 7 illustrates results on some practical cases applying the method; and

FIG. 8 illustrates an example of architecture in which the disclosed methods may be performed.

### DETAILED DESCRIPTION OF THE DRAWINGS

Predicting human grasps, is a very challenging problem as it requires modeling the physical interactions and contacts between a high-dimensional hand model and a potentially noisy 3D representation of the objects estimated from the input RGB images. This is a significantly more complex problem than that of generating robotic grasps, as robot end-effectors have much less degrees of freedom (DoF) than the human hand.

Furthermore, the common practice in robotics is to use RGB-D cameras which, despite simplifying the process of modeling the geometry of the objects, do not have the versatility of standard RGB cameras.

The method is based in a deep generative network, which splits out the determination of the grasping hand model in a classification task and a regression task, allowing to select a hand pose and to refine it for improving the quality of the model. Therefore, a coarse-to-fine approach is used, where hand model prediction is first addressed as a classification problem followed by a refinement stage. Further, different grasping qualities are maximized at the same time, improving grasping hand models generated.

Preferably, the method could employ the MANO model, which is a 51-degrees of freedom human hand model, thus, increasing the capacity of robots to perform more difficult grasps. This model also increases the accuracy of the final output by defining and refining the model comprising more degrees of freedom.

The method represents a generative model with a GAN architecture (Generator and Discriminator), which comprises the following steps:
a) obtaining at least one image comprising at least one object;
b) estimating a pose and shape of the object from the first image of the object;
c) predicting a grasp taxonomy from a set of grasp taxonomies by means of artificial neural networks algorithms, preferably, a Convolutional Neural Network, with a cross entropy loss Lclass (later defined), thus, obtaining a set of parameters defining a grasping hand model;
d) refining the grasping hand model, by minimizing loss functions referring to the parameters of the grasping hand model; and
e) obtaining a representation of a hand grasping the object by using the refined grasping hand model, preferably obtaining a mesh of said hand pose.

Therefore, the model allows, given at least one input image, to: 1) estimate or regress the 6D pose (or 3D pose and 3D shape) of the objects in the scene; 2) predict the best grasp type according to a taxonomy; and 3) refine a coarse hand configuration given by the grasping taxonomy to gracefully adjust the fingertips to the object shape, through an optimization of the 51 parameters of the MANO model that minimize a graspability loss. This process involves maximizing the number of contact points between the object and the hand shape model while minimizing the interpenetration.

The method could be configured for receiving as input an RGB image or a depth image of an object, or alternatively, a 3D image. Although depth images encode 3D information, they only correspond to a partial 3D information of the object, ignoring the occluded 3D surface.

In order to predict feasible grasps, an understanding is needed of the semantic content of the image, its geometric structure and all potential interactions with a hand physical model, which is carried out by the step of estimating a pose and shape of the object.

Said step could be performed by carrying out an object reconstruction phase, thus, obtaining a cloud of points representing the object from the obtained image, preferably by using a pre-trained and fine-tuned ResNet-50. This reconstruction method does not require knowing the object beforehand but is not reliable in case of multiple objects.

In case the RGB image comprises more than one object, steps b) to e) above would be repeated for each object in the image, assuming that the objects are known.

During training, one object is randomly selected at a time, whose 3D shape is known, said 3D shape is projected onto the image plane to obtain a segmentation mask that is then concatenated with the input image while the original RGB image gives contextual information about the entire scene for a more operable grasp.

The method enables predicting operable grasps, even in cluttered scenes with multiple objects in close contact, and predicting how a human would grasp one or several objects, given one or more images of these objects.

The input image could be encoded using a pretrained Convolutional Neural Network, preferably a ResNet architecture, and a coarse configuration of the most probable hand pose that would grasp the object is obtained. This initial estimation is formulated as a classification problem, among a reduced number of taxonomies. Therefore, the grasp class C that best suits the target object is predicted from the taxonomies by using a classification network with a cross entropy loss Lclass, defined by Eq. 1. Preferably a set of 33-grasp taxonomy is selected.

L_{class}=Σ_{c∈K}C_{o,c} log(1−P_{o,c}) EQ. 1

In Eq. 1, C represents a grasp type for the particular object (o), c represents the grasp classes among the K possible grasps classes, and P represents pose predictions for the particular object (o).

The predicted grasping hand model is centered on itself and will be aligned in the camera coordinate system. Therefore, the step of selecting a grasp taxonomy could further comprise a phase of predicting an absolute translation and rotation of the hand pose and a configuration of the hand pose by means of a fully connected network for aligning the hand pose to the camera coordinate system. At training, the absolute rotation represents the rotation from a ground truth grasp with added noise. Thus, an absolute rigid pose of a coarse estimation of the hand is obtained, adding an increment for the translation and rotation and the coarse configuration. It was observed that using this strategy of predicting the increment for each of the parameters significantly speeds up convergence during training and improves results.

The different taxonomies are created by clustering a large number of hand poses, thus, defining a number of grasp classes that could be used as an initial stage to roughly approximate the hand configuration.

The classification result is, therefore, a coarse representation, which requires it to be aligned with the object and refined. Therefore, the hand model is refined such that it is adapted to the object geometry.

To enforce the feasibility of the predicted grasping hand models, a differentiable and parameter-free layer based in a GAN architecture is used, where a discriminator classifies the feasibility of the grasp given the hand pose and contact points, thus maximizing grasp metrics. Thus, the discriminator ensures that the predicted hand shapes are operable by avoiding self-collisions with other objects within a scene.

A refinement module is used, preferably being a fully connected network, that takes as input the output of the classification problem and the geometric information about the object, to output a refined predicted hand pose Ho, a rotation Ro and a relative translation To, where the positions of the fingers are optimized to gracefully fit the object 3D surface.

Said refinement step is performed by optimizing a loss function that minimizes the distance between the hand model and the object, while preventing the interpenetration and aiming to generate human-like grasps. The loss functions to be optimized is a combination of the following group:
Distance between the object vertices and arcs obtained when rotating an angle of the finger's vertices about joint axes. In this case, for each finger 3 rotations are considered, one for each articulation. Following the kinematic chain, from the knuckle to the last joint, the finger is bent, within its physical limits, until it contacts the object.
Formally, this is achieved by minimizing the distance (D) between the object vertices (Oₖ) and any of the arcs obtained when rotating an angle θ the finger's vertices about the joint axes, as represented in Eq. 2:

D_{θ}←minᵢ(minₖ(∥Aᵢ^{θ}, Oₖ∥₂)) Eq. 2

Wherein Aᵢ^{θ} is the arc obtained when rotating θ degrees the i-th vertex of the finger from the set of object vertices (Oₖ).

Given Eq. 2 to compute the arc, the angle (γ′ⱼ) that the finger needs to be rotated around the first joint to collide with the object can then be estimated, which is represented by the Eq. 3:

γ′ⱼ←arg min_{θ} D_{θ}+δ, ∀θs.t. D_{θ}<t_{d} Eq. 3

Wherein δ (angle) is a hyperparameter that controls the interpenetration of the hand into the object and hence the grasp stability. Additionally, an upper boundary threshold (t_{d}) is defined, for defining when there is object-finger contact, preferably 2 mm.
From these two equations the following loss functions can be defined that will be used to train the model:

$${L}_{a r c} = \frac{1}{\vert J \vert} {\sum }_{j ∈ J} {D}_{θ}^{j} {L}_{γ} ← {\sum }_{j}^{J} {‖ {γ}_{j}^{′} - {γ}_{j} ‖}_{2} \qquad Eq . 4$$

Wherein |J|=5 is the number of fingers, L_{arc} aims to minimize the hand-object distances when rotating the first joint of each finger, and L_{γ} directly operates on the estimated angles and compares them with the ground truth ones γⱼ, at training.
Distance between the fingertips and the object 3D surface. To enforce the stability of the grasps, firstly, hand vertices in the fingers (V_{cont}) that are more likely to be in contact with the target object (O^{t}) are identified and the loss defined by Eq. 5 is optimized:

$${L}_{c o n t} = \frac{1}{\vert {V}_{c o n t} \vert} {\sum }_{v ∈ {V}_{cont}} {min}_{k} {‖ v , {O}_{k}^{t} ‖}_{2} \qquad Eq . 5$$

Wherein hand vertices in the fingers (V_{cont}) are computed as the vertices close to the object in at least 8% of the ground truth samples from the training. They are mostly concentrated on the fingertips and the palm of the hand.
Interpenetration between the hand and the object. If the fingers are close enough to the object surface and the hand shape is operable, the previous losses can reach a minima even if the hand is incorrectly placed inside the object. To avoid this situation, the interpenetration between the predicted hand and reference object meshes is penalized.
For doing this, a ray is beamed from the origin camera position to each hand vertex and counting the number of times the ray intersects the object, determining whether hand vertices are inside or outside the object. Considering Vᵢ to be the set of hand vertices that are inside the object, the minimum distance of each of them to the closest object surface point may be minimized using the loss function:

$${L}_{i n t} = \frac{1}{\vert {V}_{i} \vert} {\sum }_{j}^{\vert O \vert} {\sum }_{v ∈ {V}_{i}} {min}_{k} {‖ v , {O}_{k}^{j} ‖}_{2} \qquad Eq . 6$$

Interpenetration below the table plane. Hand configurations that are below the table plane are penalized, by calculating the distance from each hand vertex to the table plane, and favoring this distance to be positive.

Lₚ=Σᵥ^{V} min(0, |(v−pₚ)·vₚ|) Eq. 7

Wherein pₚ represents a point of the table plane and vₚ represents a normal pointing upwards.
Anthropomorphic hands. To generate anthropomorphic hands and operable grasping hand models, a discriminator D trained using a Wasserstein loss is introduced. G being the trainable model defined, H*, R*, T* the ground truth training samples (samples from the training set), and \tilde{H}, \tilde{R}, \tilde{T} interpolations between correct samples and predictions. Then, the adversarial loss is defined as:

L_{adv}=−E_{H,R,T˜p(H,R,T)}[D(G(I))]+E_{H,R,T˜p(H,R,T)}[D(H*, R*, T*)] Eq. 8

Additionally, to guarantee the satisfaction of the Lipschitz constraint in the W-GAN, introduce a gradient penalty loss L_{gp}.

Finally, the total loss L to be minimized is a linear combination of all previous loss functions, corresponding different weights to each loss: L_{class}, L_{arc}, L_{gp}, L_{γ}, L_{cont}, Lᵢₙₜ, Lₚ, L_{adv}.

L=λ_{class}L_{class}+λ_{arc}L_{arc}+λ_{gp}L_{gp}+λ_{γ}L₆₅ +λ_{cont}L_{cont}+λᵢₙₜLᵢₙₜ+λₚLₚ+λ_{adv}L_{adv} Eq. 9

Wherein λ_{class}, λ_{arc}, λ_{gp}, λ_{γ}, λ_{cont}, λₚ, λ_{adv} are hyper-parameters weighing the contribution of each loss function.

Objects can generally be grasped in several ways. Therefore, the object could be randomly rotated several times on the Quaternion sphere, and for each rotation, the refinement network generates an operable grasp for said orientation. Thus, the method allows prediction of a set of different operable grasps for the same object.

Then the operable grasps generated may be evaluated by calculating metric parameters, and the highest-scoring ones would be selected. Such grasps may be evaluated using different metrics, such as:
An analytical grasp metric, which computes an approximation of the minimum force to be applied to break the grasp stability.
An average number of contact fingers, wherein numerous contact points between hand and object favor a strong grasp.
A hand-object interpenetration volume, wherein object and hand are voxelized, and the volume shared by both 3D models is computed.
A simulation displacement of the object mesh subjected to gravity.
A percentage of graspable objects for which an operable grasp could be predicted, being an operable grasp the one with at least two contact points and no interpenetration.

The method could also take into account object grasping preferences given functional intent, shape, and semantic category, for improving grasping model. The method could also be employed to synthesize training examples in a data-driven framework.

The method has an enormous potential in several fields, including virtual and augmented reality, human-robot interaction, robot imitation learning, and new avenues in areas like prosthetic design.

The method determines a grasping hand model. The method takes as input an RGB image, which is proposed so as to determine a coarse grasping hand model, i.e. a hand configuration a translation and a rotation vector. The coarse grasping hand model is obtained by using a neural network as a classification problem, wherein a grasp taxonomy is selected from a group of taxonomies. Then, the coarse grasping hand model is refined by optimizing one or more loss functions, thus obtaining a refined hand shape and pose.

In particular, the method may be used to determine grasping possibilities given an RGB image comprising multiple objects in a cluttered scene.

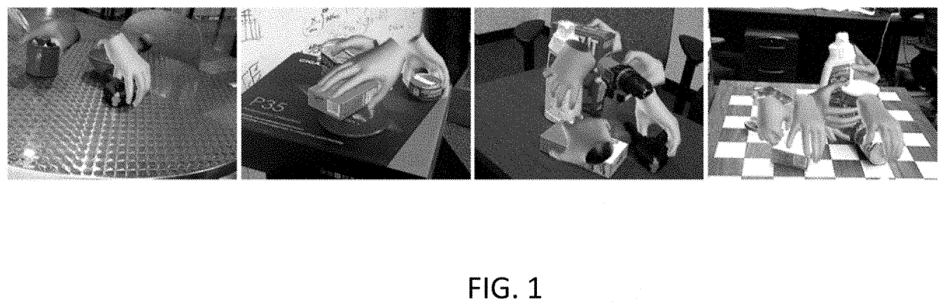

The method is applied to each object in a scene, and grasping hand models for each object are obtained. In FIG. 1, the grasping hand models obtained for the objects of each image are shown. The figure shows four sample results on a YCB-Affordance dataset, which has been created for testing the method.

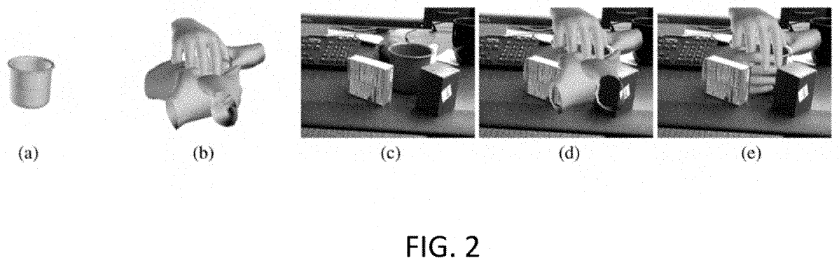

FIG. 2 shows steps of a training method for annotating images so as to train the neural networks for obtaining grasping hand models. The training method in this case is applied to an image having three objects. Firstly, a model of one of the objects is obtained, as depicted in step a). Then, manually, a set of operable grasping hand models is annotated over the model; in this case just 5 hand models are depicted in step b). An image is obtained, wherein the object is contained, and more objects are also present, as in case of step c). Then, all the grasping hand models are transferred to the image as shown in step d). From all the grasping hand models transferred, just operable hand models are selected, wherein said operable hand models do not collide with other objects in the scene. In case of step e), only three hand models are selected for representation, but a lot of more hand models could be obtained. The training method allows the obtaining of annotated images which feeds the neural networks.

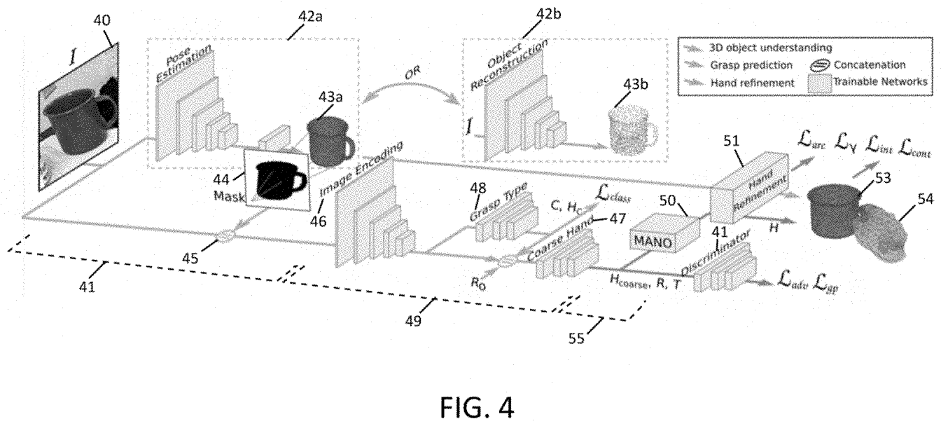

FIG. 4 shows a representation of the method. Generally, the method consists of three stages. In a first stage, the objects' shapes and locations are estimated in a scene using a first sub-network 41 that is an object 6D pose estimator 42a (which is used when you know the object you want to manipulate) or a reconstruction network 42b (which is used when the object is unknown). In a second stage, a mask and input image are fed to a second sub-network 49 for grasp prediction. In a third stage, the hand parameters are refined and the hand final shapes and poses are obtained using the parametric model MANO

More specifically, the method, as illustrated in FIG. 4, comprises the steps of:
obtaining a single RGB image 40 of one or several objects for predicting how a human would grasp these objects naturally,
feeding a first sub-network 41 for 3D object understanding for estimating objects' shapes and locations in the scene using an object 6D pose estimator 42a or a reconstruction network 42b,
the predicted shape (43a from an object 6D pose estimator 42a or 43b from reconstruction network 42b) is then projected onto the image plane to obtain a segmentation mask 44,
concatenating at 45 the segmentation mask 44 with the input image 40,
feeding a second sub-network 49 for grasp prediction (which includes image encoding network 46, grasp type network 48 and coarse hand network 47) with the segmentation mask concatenated with the image at 45,
obtaining a coarse hand model (with parameters H_{coarse} (hand), R (rotation), T (translation)) output from coarse hand network 47 from a grasp prediction neural network 48 (which predicts a class label C with corresponding shape of the hand H_{C}) using rotation input R₀, and
refining, with a third sub-network 55, hand parameters of the coarse hand model output by coarse hand network 47 (having parameters C and H_{C}) for obtaining a refined hand model output from hand refinement network 51 (having parameters H_{coarse}, R (rotation) and T (translation)), which in this embodiment uses the parametric model MANO 50, the hand refinement network 51 refining the position of the fingers of the hand 54 to fit the object 53 segmented by the first sub-network 41.

The method is trained using adversarial, interpenetration, classification, and optimization losses using discriminator 41, which is only used at training and not at inference (i.e., runtime).

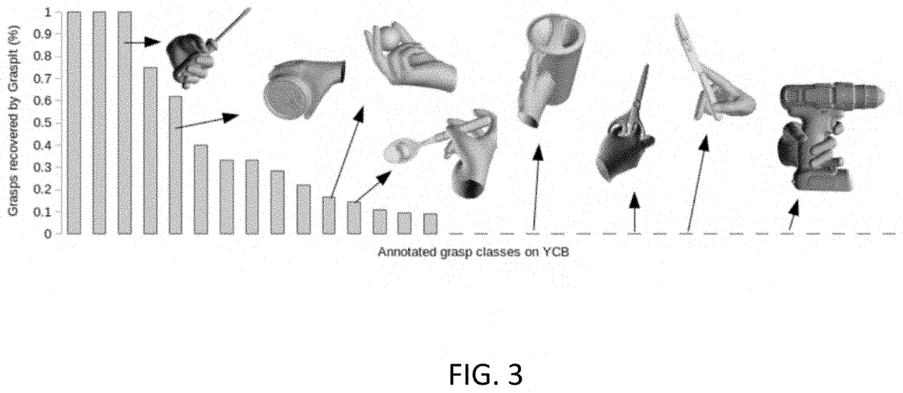

FIG. 3 shows a comparison between the method and a simulator known in the state of the art: GraspIt. In the FIG. 3, it is shown a percentage of hand models found through the simulator compared to the ones obtained with the method.

When provided with the CAD models of the objects, the simulator only recovered a portion of the natural grasps that are annotated in the method. Therefore, manually annotating the hand models in the training method provides more realism to the hand models obtained by the method. As shown, the simulator is able to obtain the same number of operable hand models in simple objects. However, few operable hand models are found by the simulator while hands are on objects which require abducted thumbs or accurate grasps operable.

For evaluating the quality of the grasping hand models generated, some evaluation metrics are considered:
An analytical grasp metric is used to score a grasp, which computes an approximation of the minimum force to be applied to break the grasp stability.
An average number of contact fingers can also be used to measure the quality of a grasp since numerous contact points between hand and object favor a strong grasp.
A hand-object interpenetration volume could be computed. Object and hand are voxelized, and the volume shared by both 3D models is computed, using a voxel size of 0.5 cm³.
A simulation displacement of the object mesh is computed, when said object is subjected to gravity in simulation.
A percentage of graspable objects for which an operable grasp could be predicted is computed, being an operable grasp the one with at least two contact points and no interpenetration.

The method has been trained for grasp affordance prediction in multi-object scenes using natural images showing multiple objects annotated with operable human grasps.

Therefore, a first large-scale dataset that includes hand pose and shape for natural and operable grasping in multi-object scenes has been collected. To do so, a YCB-Video Dataset with operable human grasps has been augmented. The YCB dataset contains more than 133K frames from videos of 92 cluttered scenes with highly occluded objects whose 6D pose was annotated in camera coordinates.

Thus, a dataset has been created, called YCB-Affordance, which features grasps for all objects from the YCB Object set for which a CAD model was available. These include 58 diverse household objects of particular interest for grasping and manipulation tasks, such as tools, cutlery, food or more basic shape structures.

Each CAD model was first annotated with operable grasps, and, then, the resulting grasps were transferred to the YCB scenes and images, yielding more than 28 million grasps for 133K images.

In the annotation step, operable grasps were manually annotated to cover all possible ways to naturally pick up or manipulate the objects. In this case, the visual interface of the GraspIt simulator was used to manually adapt the hand palm position and rotation, and each of the finger joint angles.

An integration of the GraspIt simulator with a Skinned Multi-Person Linear Model (SMPL) is used to directly retrieve a low-dimensional MANO representation of the hand model, and to obtain posed and registered hand shape meshes.

On average, symmetric objects, such as cans or bottles, were annotated with 6 distinct grasps, and more complex objects, such as tools or cutlery, were annotated with up to 12 different grasps. In total, 367 different fine-grained grasps were manually annotated and a grasp type within a 33-grasp taxonomy was assigned to.

The taxonomy was defined considering the position of the contact fingers, the level of power/precision tradeoff in the grasp and the position of the thumb. Then, rotational symmetries were annotated in all the objects from the YCB Object set considering each main axis.

A rotational symmetry is represented by its order, which indicates the number of times an object can be rotated on a particular axis and results in an equivalent shape. Taking advantage of objects' symmetry, the number of grasps has been automatically extended by simply rotating the hand around the axes, e.g. repeating grasps along the revolution axis.

The generation of grasps using GraspIt simulator only leads to a reduced set of grasping hand models which maximize the analytical grasp score but are not necessarily correct or natural, e.g. holding a knife by the blade or grasping a cup with 2 fingers. Instead of that, in the YCB-Affordance dataset, by manually annotating the images only operable grasping hand models are included, even hand models that GraspIt would never find, such as grasping scissors.

The scenes in the YCB-Video Dataset contain between 3 and 9 objects in close contact. Often, the placement of the objects makes them not easily accessible for grasping without touching other objects. For this reason, only the scenes with operable and feasible grasps are annotated, i.e. grasps for which the hand does not collide with other objects.

To do so, the 6D pose annotations of the CAD models in camera coordinates available for the different objects are used. Also, for a more complete 3D representation of the scene, the position of the table plane is also manually annotated. In practice, this was manually done in the first frame of each video and propagated through the remaining frames using the motion of the camera in consecutive frames.

Then, all the grasps annotated on the 3D CAD models are transferred to the real scenarios, using ground-truth 6D object poses and selecting only operable grasps for which the hand 3D mesh does not intersect with the objects 3D CAD models or the table plane. In most cases, several possible grasps remain operable for each object.

However, the YCB Video dataset contains a few challenging scenes where an object is placed in a way that other objects occlude it too much for it to be grasped without any collision. In such cases, the object is considered as not reachable and left without grasp annotation. The final dataset contains 133,936 frames with more than 28M operable grasp annotations, which is a suitable size to train deep networks.

The contribution of an optimization layer is evaluated when included in a state-of-the-art method for hand shape estimation. Then, the method is validated on the single-object synthetic ObMan dataset and fully evaluated in multi-object scenes with the YCB-Affordance dataset created.

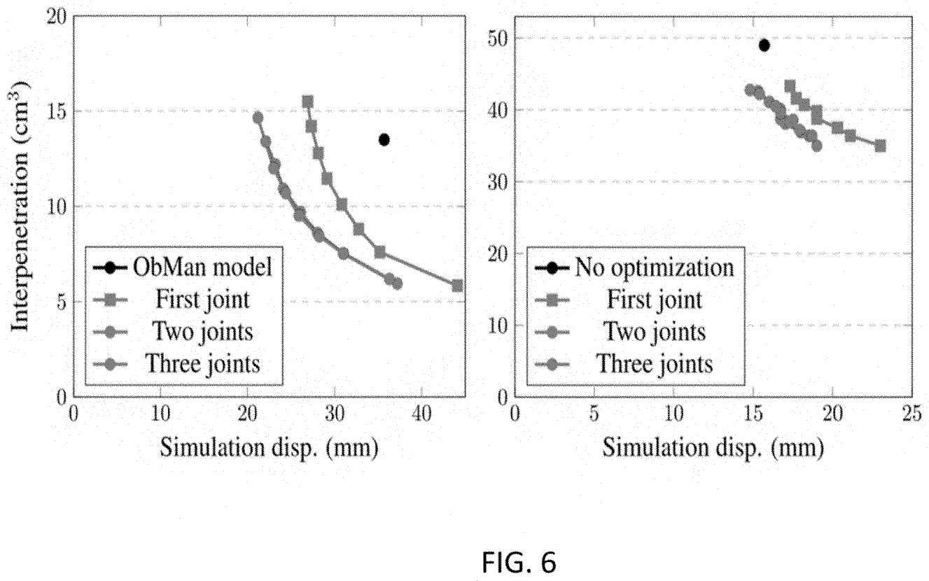

FIG. 6 shows quantitative data of the impact of the optimization layer, both in the hand-object reconstruction pipeline and in the grasp prediction pipeline. The angle of rotation of the finger around a joint for minimizing the distance between the finger and the object is modulated by a hyperparameter (δ). FIG. 6 shows a trade-off between interpenetration and the simulation displacement, by varying the hyperparameter (δ), having into account that the lower the interpenetration and the simulation displacement are the better the hand model is considered. First, first and second, and all three joints of each finger are optimized by the optimization layer and the results are depicted in FIG. 6.

In the left graph, the contribution of the optimization layer in the hand-object reconstruction pipeline is shown, and in the right graph, the contribution of the optimization layer in grasp prediction is shown. As shown, the proposed layer provides a significant improvement in the hand-object reconstruction results, reducing simulation displacement and interpenetration metrics by more than 30%, and also grasp prediction pipeline is improved.

In one embodiment, a baseline made of a pre-trained ResNet-50 model that directly predicts the MANO representation of the hand, rotation and translation, still using layers for ‘3D scene understanding’ and ‘hand refinement’ but lacking the grasp taxonomy prediction.

The ObMan dataset contains around 150k synthetic hand-object pairs with successful grasps produced using GraspIt for 27k different objects. Around 70k grasps were simulated for each object, keeping only the grasps with highest score. In this case, images showing each object alone were used and basic background textures were added. This is a simplified version of the method which does not consider intersections with other elements of the scene, such as the plane and objects.

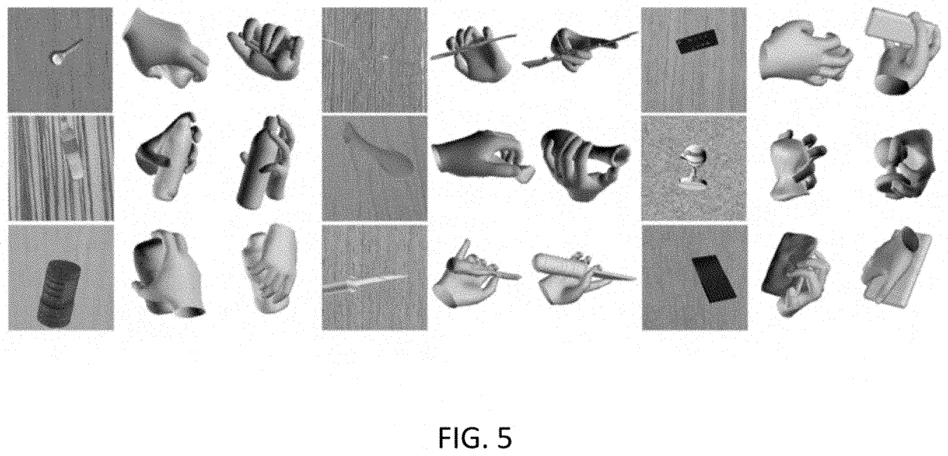

FIG. 5 shows, for each object, the input image (left), the predicted grasp when estimating the object 3D shape (middle) and when using the ground-truth object shape (right).

TABLE 1

| | Model | | | | | | | | |
|---|---|---|---|---|---|---|---|---|---|
| | Baseline | | | | GanHand | | | | Grasplt* |
| Finger joints optimized | — | 1 | 2 | 3 | — | 1 | 2 | 3 | — |
| Grasp score ↑ | 0.19 | 0.36 | 0.37 | 0.43 | 0.4 | 0.6 | 0.56 | 0.56 | 0.3 |
| Hand-Object Contacts ↑ | 2.6 | 4 | 4.4 | 4.6 | 3 | 3.9 | 4.4 | 4.4 | 4.4 |
| Interpenetration ↓ | 42 | 27 | 29 | 29 | 48 | 33 | 34 | 34 | 10 |
| Time (sec) ↓ | 0.2 | 0.3 | 0.3 | 0.4 | 0.2 | 0.3 | 0.3 | 0.4 | 300 |

In Table 1 quantitative results on comparing three grasping hand models for both GanHand and the baseline are provided. In particular the grasping hand models are obtained by evaluating both methods using optimization for 1, 2, or 3 joints. Then, the hand models having the highest grasp score are selected, which provides a good trade-off between grasp accuracy and running time.

In Table 1, the characteristics of each hand model obtained are compared such that in characteristics having the symbol ↑, the higher the punctuation the better the hand model, and on having the symbol ↓, the lower the punctuation the better the hand model. Also it is highlighted that the models obtained in the simulator case are run on ground-truth object shapes.

The method has been also tested on the YCB Affordance dataset, generated for training and testing the method. The baseline and the method were trained on 80 videos from YCB Affordance (130k frames). Test is evaluated on a different subset of 12 videos (2949 frames) of the same objects seen at train, but different scenes and poses.

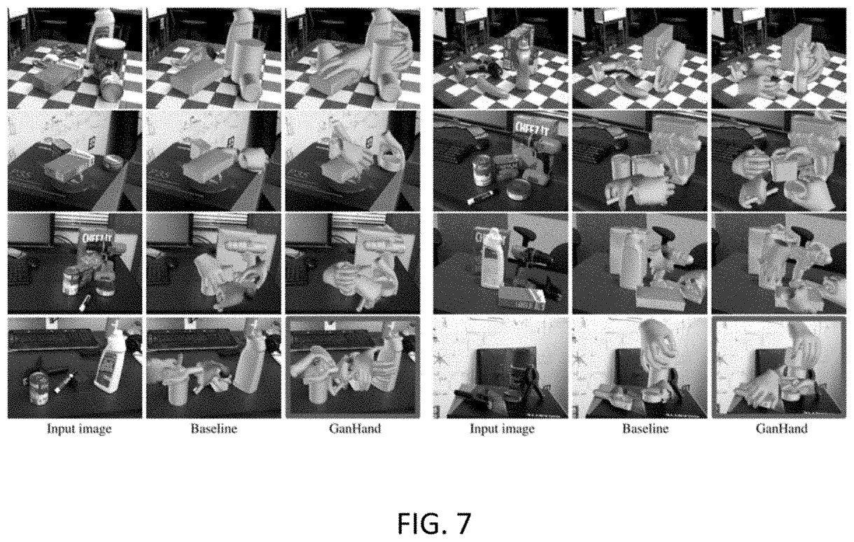

FIG. 7 shows results on some cases. As shown, the method achieves a higher % of graspable objects and a higher accuracy in predicted grasp types compared to the baseline. The plane interpenetration is considerably low for both methods, indicating that both models learnt to adequately place the hands above the tables.

Some failure cases are also highlighted in bottom row. In the case bottom left, the absolute poses of the can and clamps are not accurate and overlapping grasps are produced. In the case bottom right, the cup is detected as a brick, predicting a wrong grasp.

TABLE 2

| | Model | | | | | | | |
|---|---|---|---|---|---|---|---|---|
| | Baseline | | | | GanHand | | | |
| Finger joints optimized | — | 1 | 2 | 3 | — | 1 | 2 | 3 |
| % graspable objects ↑ | 4 | 21 | 33 | 31 | 21 | 58 | 57 | 55 |
| Acc. grasp type % ↑ | 49 | 62 | 57 | 56 | 78 | 76 | 70 | 76 |
| Grasp score ↑ | 0.37 | 0.45 | 0.44 | 0.45 | 0.36 | 0.47 | 0.46 | 0.42 |
| Hand-Object Contacts ↑ | 3.7 | 3.7 | 3.7 | 3.7 | 3.7 | 3.7 | 3.8 | 3.9 |
| Obj. Interp. (cm3) ↓ | 38 | 30 | 30 | 30 | 26 | 27 | 28 | 26 |
| Plane interp. (cm) ↓ | 0.1 | 0.1 | 0.1 | 0.1 | 0.3 | 0.3 | 0.2 | 0.3 |

In Table 2 quantitative results comparing three grasping hand models on YCB-Affordance dataset for both GanHand and the baseline are provided. The overall result is that the method (GanHand) outperforms the baseline in all metrics, except from plane interpenetration which is negligible for both methods.

In this method, up to 20 predictions are sampled and the one with least interpenetration with all predicted objects is selected. Both methods leverage the grasp variety of YCB Affordance dataset predicting a good diversity of grasps.

Also, the intended activity and the state of the object to select a more appropriate grasp may be taken into account. For instance, a human would not manipulate a cup when drinking hot liquid from it the same way when washing it.

In an implementation example, the classification module is based on a ResNet-50. The discriminator and hand pose refiner are 4-layer fully connected networks with ReLU nonlinearities and Xavier initialization.

Input images are resized to 256×256. A hyperparameter grid search is performed to maximize and train all models using LR=0.0001, BS=32, loss weights class=1, arc=0:01, cont=100, int=4000, p=20, adv=1 and gp=10 using Adam optimizer.

The Generator is trained once every 5 forward passes to improve the relative quality of the Discriminator. The model is trained for 5 epochs, and with linear LR decay for 25 epochs more.

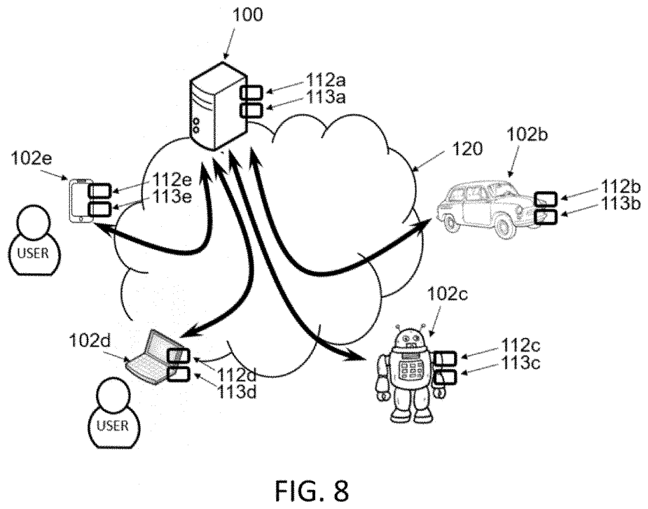

The above-mentioned methods and embodiments may be implemented within an architecture such as illustrated in FIG. 8, which comprises server 100 and one or more client devices (102b, 102c, 102d, and 102e) that communicate over a network 120 (which may be wireless and/or wired) such as the Internet for data exchange. Server 100 and the client devices (102b, 102c, 102d, and 102e) include a data processor (112a, 112b, 112c, 112d, and 112e) and memory (113a, 113b, 113c, 113d, and 113e) such as a hard disk. The client devices 102 may be any device that communicates with server 100, including autonomous vehicle 102b, robot 102c, computer 102d, or cell phone 102e.

More precisely, in one embodiment, the representation of the method illustrated in FIG. 4 may be processed at server 100 (or at a different server or alternatively directly at the client device (102b, 102c, 102d, and 102e)).

While some specific embodiments have been described in detail above (e.g., with respect to a human hand), it will be apparent to those skilled in the art that various modifications, variations, and improvements of the embodiments may be made in the light of the above teachings and within the content of the appended claims without departing from the intended scope of the embodiments (e.g., with respect to other than a human hand, such as a robot hand).

The embodiments disclosed above may be implemented as a machine (or system), process (or method), or article of manufacture by using standard programming and/or engineering techniques to produce programming software, firmware, hardware, or any combination thereof. It will be appreciated that the flow diagrams described above are meant to provide an understanding of different possible embodiments. As such, alternative ordering of the steps, performing one or more steps in parallel, and/or performing additional or fewer steps may be done in alternative embodiments.

Any resulting program(s), having computer-readable program code, may be embodied within one or more computer-readable media such as memory devices or transmitting devices, thereby making a computer program product or article of manufacture according to the embodiments. As such, the terms “article of manufacture” and “computer program product” as used herein are intended to encompass a computer program existent (permanently, temporarily, non-transitorily, or transitorily) on any computer-readable medium such as on any memory device or in any transmitting device.

A machine embodying the embodiments may involve one or more processing systems including, but not limited to, CPU, memory/storage devices, communication links, communication/transmitting devices, servers, I/O devices, or any subcomponents or individual parts of one or more processing systems, including software, firmware, hardware, or any combination or subcombination thereof, which embody the embodiments as set forth in the claims.

Those skilled in the art will recognize that memory devices include, but are not limited to, fixed (hard) disk drives, floppy disks (or diskettes), optical disks, magnetic tape, semiconductor memories such as RAM, ROM, Proms, etc. Transmitting devices include, but are not limited to, the Internet, intranets, electronic bulletin board and message/note exchanges, telephone/modem based network communication, hard-wired/cabled communication network, cellular communication, radio wave communication, satellite communication, and other wired or wireless network systems/communication links.

A method for determining a grasping hand model suitable for grasping an object, the method comprises: (a) obtaining at least one image including at least one object; (b) obtaining an object model estimating a pose and shape of said object from the first image of the object; (c) predicting a grasp taxonomy from a set of grasp taxonomies by means of an artificial neural network, thus, obtaining a set of parameters defining a coarse grasping hand model; (d) refining the coarse grasping hand model, by minimizing loss functions referring to the parameters of the hand model for obtaining an operable grasping hand model while minimizing the distance between the fingers of the hand model and the surface of the object and preventing interpenetration; and (e) obtaining a representation of a hand grasping the object by using the refined hand model.

The artificial neural network may be a Convolutional Neural Network, with a cross entropy loss L_{class} defined as:

L_{class}=Σ_{c∈K}C_{o,c} log(1−P_{o,c});

wherein C represents a grasp type for the particular object (o), c represents the grasp classes among the K possible grasps classes, and P represents pose predictions for the particular object (o)

The representation obtained in (e) may be a mesh of the refined hand model.

The hand model may be represented by using a MANO model, being a 51 degrees of freedom (DoF) model of a possible human hand.

The method may further include (f) evaluating the grasping hand model obtained by calculating at least one evaluating metric of an analytical grasp metric, which computes an approximation of the minimum force to be applied to break the grasp stability; an average number of contact fingers, wherein numerous contact points between hand and object favor a strong grasp; a hand-object interpenetration volume, wherein object and hand are voxelized, and the volume shared by both 3D models is computed; a simulation displacement of the object mesh subjected to gravity; and a percentage of graspable objects for which an operable grasp could be predicted, being an operable grasp the one with at least two contact points and no interpenetration.

The method may further include (f) randomly rotating the object model; (g) obtaining a grasping hand model for each rotated object model, by repeating (c) to (e); (h) evaluating each rotated grasping hand model using evaluating metrics; and (i) selecting the rotated grasping hand models having the highest score.

The estimating a pose and shape of the object may comprise an object reconstruction phase for obtaining a cloud of points representing the object form the obtained image.

The RGB image may comprise more than one object and the method further comprises the step of repeating (b) to (e) for each object in the image, wherein the objects are known.

The selecting a grasp taxonomy may comprise a phase of predicting an increment of translation and rotation of the hand model and a modified coarse configuration of the hand model by means of a fully connected network.

The refining the coarse grasping model may comprise (d1) selecting at least one articulation (i) of the hand model; (d2) calculating an arc (Ai) between a finger (j) of the hand model and close object vertices (O), D_{θ}←minᵢ(minₖ(∥Aᵢ^{θ}, Oₖ∥₂)); (d3) estimating the angle the finger needs to be rotated to collide with the object, rotating the articulation for minimizing the arc, thus, reducing the distance between the hand model and the object vertices, including a hyperparameter for controlling the interpenetration of the hand model into the object, γ′ⱼ←arg min_{θ}D_{θ}+δ, ∀θs.t. D_{θ}<t_{d}; (d5) defining the following loss functions:

$${L}_{a r c} = \frac{1}{\vert J \vert} {\sum }_{j ∈ J} {D}_{θ}^{j} {L}_{γ} ← {\sum }_{j}^{J} {‖ {γ}_{j}^{′} - {γ}_{j} ‖}_{2} ;$$

and (d6) minimizing the loss functions defined.

The refining the coarse grasping model may comprise repeating phases (d2) to (d3) for each articulation sequentially from the knuckle to the tip for each finger.

The refining the coarse grasping model may further comprise minimizing a loss function selected from: a distance between the hand vertices and the target object, wherein is considered that there is a contact when the distance is below to 2 mm, defined by:

$${L}_{c o n t} = \frac{1}{\vert {V}_{c o n t} \vert} {\sum }_{v ∈ {V}_{cont}} {min}_{k} {‖ v , {O}_{k}^{t} ‖}_{2} ;$$

a distance of interpenetration between a vertex of the hand model and the object, defined by:

$${L}_{i n t} = \frac{1}{\vert {V}_{i} \vert} {\sum }_{j}^{\vert O \vert} {\sum }_{v ∈ {V}_{i}} {min}_{k} {‖ v , {O}_{k}^{j} ‖}_{2} ;$$

a distance below a table plane, between a vertex of the hand model and the table plane, wherein the distance is favored to be positive, defined by: Lₚ=Σᵥ^{V} min(0, |(v−pₚ)·vₚ|); and an adversarial loss function, using a Wasserstein loss including a gradient penalty loss, defined by: L_{adv}=−E_{H,R,T˜p(H,R,T)}[D(G(I))]+E_{H,R,T˜p(H,R,T)}[D(H*, R*, T*)].

The hand may be a human hand.

A system for determining parameters of a model of a hand suitable for grasping an object, comprises a first neural network for segmenting the object in an image and estimating a 3D shape of the segmented object; a second neural network for predicting parameters of the model of the hand that define a pose for grasping the segmented object; and a third neural network for refining the predicted parameters of the model of the hand to fit the segmented object.

The hand may be a human hand.

A method for determining parameters of a model of a hand suitable for grasping an object, comprises segmenting with a first neural network the object in an image and estimating a 3D shape of the segmented object; predicting with a second neural network parameters of the model of the hand that define a pose for grasping the segmented object; and refining with a third neural network the predicted parameters of the model of the hand to fit the segmented object.

The hand may be a human hand.

A computer program product non-transitorily existent on a computer-readable media for determining a grasping hand model suitable for grasping an object comprising code instructions, when the computer program product is executed on a computer, to execute a method for determining a grasping hand model suitable for grasping an object; the code instructions, when determining a grasping hand model suitable for grasping an object, (a) obtains at least one image including at least one object, (b) obtaining an object model estimating a pose and shape of said object from the first image of the object, (c) predicts a grasp taxonomy from a set of grasp taxonomies by means of an artificial neural network, thus, obtaining a set of parameters defining a coarse grasping hand model, (d) refines the coarse grasping hand model, by minimizing loss functions referring to the parameters of the hand model for obtaining an operable grasping hand model while minimizing the distance between the fingers of the hand model and the surface of the object and preventing interpenetration, and (e) obtains a representation of a hand grasping the object by using the refined hand model.

A non-transitory computer-readable media, on which is stored a computer program product, comprises code instructions, when the computer program product is executed on a computer, to execute a method for determining a grasping hand model suitable for grasping an object; the code instructions, when determining a grasping hand model suitable for grasping an object, (a) obtains at least one image including at least one object, (b) obtaining an object model estimating a pose and shape of said object from the first image of the object, (c) predicts a grasp taxonomy from a set of grasp taxonomies by means of an artificial neural network, thus, obtaining a set of parameters defining a coarse grasping hand model, (d) refines the coarse grasping hand model, by minimizing loss functions referring to the parameters of the hand model for obtaining an operable grasping hand model while minimizing the distance between the fingers of the hand model and the surface of the object and preventing interpenetration, and (e) obtains a representation of a hand grasping the object by using the refined hand model.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

What is claimed is:

1. A method for determining a grasping hand model suitable for grasping an object, the method comprising:
(a) obtaining at least one image including at least one object;
(b) obtaining an object model estimating a pose and shape of said object from the first image of the object;
(c) predicting a grasp taxonomy from a set of grasp taxonomies by means of an artificial neural network, thus, obtaining a set of parameters defining a coarse grasping hand model;
(d) refining the coarse grasping hand model, by minimizing loss functions referring to the parameters of the hand model for obtaining an operable grasping hand model while minimizing the distance between the fingers of the hand model and the surface of the object and preventing interpenetration; and
(e) obtaining a representation of a hand grasping the object by using the refined hand model.

2. The method according to claim 1, wherein the artificial neural network is a Convolutional Neural Network, with a cross entropy loss L_{class} defined as:
L_{class}=Σ_{c∈K}C_{o,c} log(1−P_{o,c});
wherein C represents a grasp type for the particular object (o), c represents the grasp classes among the K possible grasps classes, and P represents pose predictions for the particular object (o).

3. The method according to claim 1, wherein the representation obtained in (e) is a mesh of the refined hand model.

4. The method according to claim 1, wherein the hand model is represented by using a MANO model, being a 51 degrees of freedom (DoF) model of a possible human hand.

5. The method according to claim 1, further comprising:
(f) evaluating the grasping hand model obtained by calculating at least one evaluating metric of an analytical grasp metric, which computes an approximation of the minimum force to be applied to break the grasp stability; an average number of contact fingers, wherein numerous contact points between hand and object favor a strong grasp; a hand-object interpenetration volume, wherein object and hand are voxelized, and the volume shared by both 3D models is computed; a simulation displacement of the object mesh subjected to gravity; and a percentage of graspable objects for which an operable grasp could be predicted, being an operable grasp the one with at least two contact points and no interpenetration.

6. The method according to claim 5, further comprising:
(f) randomly rotating the object model;
(g) obtaining a grasping hand model for each rotated object model, by repeating (c) to (e);
(h) evaluating each rotated grasping hand model using evaluating metrics; and
(i) selecting the rotated grasping hand models having the highest score.

7. The method according to claim 1, wherein said estimating a pose and shape of the object comprises an object reconstruction phase for obtaining a cloud of points representing the object form the obtained image.

8. The method according to claim 1, wherein the RGB image comprises more than one object and the method further comprises the step of repeating (b) to (e) for each object in the image, wherein the objects are known.

9. The method according to claim 1, wherein said selecting a grasp taxonomy further comprises a phase of predicting an increment of translation and rotation of the hand model and a modified coarse configuration of the hand model by means of a fully connected network.

10. The method according to claim 1, wherein said refining the coarse grasping model, comprises:
(d1) selecting at least one articulation (i) of the hand model;
(d2) calculating an arc (Ai) between a finger (j) of the hand model and close object vertices (O),
D_{θ}←minᵢ(minₖ(∥Aᵢ^{θ}, Oₖ∥₂));
(d3) estimating the angle the finger needs to be rotated to collide with the object, rotating the articulation for minimizing the arc, thus, reducing the distance between the hand model and the object vertices, including a hyperparameter for controlling the interpenetration of the hand model into the object,
γ′ⱼ←arg min_{θ} D_{θ}+δ, ∀θs.t. D_{θ}<t_{d};
(d5) defining the following loss functions:
$${L}_{a r c} = \frac{1}{\vert J \vert} {\sum }_{j ∈ J} {D}_{θ}^{j} {L}_{γ} ← {\sum }_{j}^{J} {‖ {γ}_{j}^{′} - {γ}_{j} ‖}_{2} ;$$
and
(d6) minimizing the loss functions defined.

11. The method according to claim 10, wherein said refining the coarse grasping model, further comprises repeating phases (d2) to (d3) for each articulation sequentially from the knuckle to the tip for each finger.

12. The method according to claim 1, wherein said refining the coarse grasping model, further comprises minimizing a loss function selected from:
a distance between the hand vertices and the target object, wherein is considered that there is a contact when the distance is below to 2 mm, defined by:
$${L}_{c o n t} = \frac{1}{\vert {V}_{c o n t} \vert} {\sum }_{v ∈ {V}_{cont}} {min}_{k} {‖ v , {O}_{k}^{t} ‖}_{2} ;$$
a distance of interpenetration between a vertex of the hand model and the object, defined by:
$${L}_{i n t} = \frac{1}{\vert {V}_{i} \vert} {\sum }_{j}^{\vert O \vert} {\sum }_{v ∈ {V}_{i}} {min}_{k} {‖ v , {O}_{k}^{j} ‖}_{2} ;$$
a distance below a table plane, between a vertex of the hand model and the table plane, wherein the distance is favored to be positive, defined by:
Lₚ=Σᵥ^{V} min(0, |(v−pₚ)·vₚ|); and
an adversarial loss function, using a Wasserstein loss including a gradient penalty loss, defined by:
L_{adv}=−E_{H,R,T˜p(H,R,T)}[D(G(I))]+E_{H,R,T˜p(H,R,T)}[D(H*, R*, T*)].

13. A method according to claim 1, wherein the hand is a human hand.

14. A system for determining parameters of a model of a hand suitable for grasping an object, comprising:
a first neural network for segmenting the object in an image and estimating a 3D shape of the segmented object;
a second neural network for predicting parameters of the model of the hand that define a pose for grasping the segmented object; and
a third neural network for refining the predicted parameters of the model of the hand to fit the segmented object.

15. A system according to claim 14, wherein the hand is a human hand.

16. A method for determining parameters of a model of a hand suitable for grasping an object, comprising:
segmenting with a first neural network the object in an image and estimating a 3D shape of the segmented object;
predicting with a second neural network parameters of the model of the hand that define a pose for grasping the segmented object; and
refining with a third neural network the predicted parameters of the model of the hand to fit the segmented object.

17. A method according to claim 16, wherein the hand is a human hand.
